(19) United States
(12) Patent Application Publication
(10) Pub. No.: US 2007/0131298 A1
(43) Pub. Date: Jun. 14, 2007

(54) Kink proof flat type water hose

(76) Inventor: Jieh-Ming Ueng, Shuh-Lin City (TW)

Correspondence Address: RABIN & BERDO, P.C., Suite 500, 1101 14 Street, N.W., Washington, DC, 20005, US

(21) Appl. No.: 11/296,275

(22) Filed: Dec. 8, 2005

(51) Int. Cl. F16L 11/00

(52) U.S. Cl. 138/115; 138/125; 138/126

(57) ABSTRACT

A kink proof flat type water hose comprising inner layer, fiber layer and outer layer; several connecting boards in parallel with flow direction subdivides the inner layer into more than two flow paths, the hose is in flat ellipse shape; based on above structure, such can prevent fluid being blocked when hose is over-bent or compressed; the present invention has several flow paths, while application, not all the flow paths suffer block or compression, fluid transportation function remains.

### BACKGROUND OF THE INVENTION

I. Field of the Invention

This invention relates generally to a water hose and, more specifically, to a kink proof flat type water hose that has inner support and more than two flow paths to prevent fluid being blocked when hose is over-bent or compressed.

II. Description of the Prior Art

Heretofore, it is known when people want to wash car or transport water in short range, or sprinkle lawn, usually they connect water hose to water faucet and apply internal path of water hose to convey water to destination; referring to FIG. 1, the internal of general water hose a is round hollow shape; while conveying water, by different transmission distance, users will apply different length of water hose a, however when users want to stretch water hose a, sometimes water hose a might be bent or tied together, the water flow of water hose a is reduced for compression, or no water at end for water hose a is over bent. When water hose a crosses over roadway, and when pedestrian or automobile across, water hose will stop water transmission; how to strengthen hose wall for better support becomes one of hose manufacturers, major issues.

### SUMMARY OF THE INVENTION

It is therefore a primary object of the invention to provide a kink proof flat type water hose that strengthens the support of hose to prevent fluid being blocked when hose is over-bent or compressed.

In order to achieve the objective set forth, a kink proof flat type water hose in accordance with the present invention comprises inner layer, fiber layer and outer layer; several connecting boards in parallel with flow direction subdivides the inner layer into several flow paths, the hose is in flat ellipse shape.

Based on above description, the connecting boards inside the inner layer are in parallel with flow direction to subdivide inner layer into more than two flow paths for stronger support and hose strength, such can prevent fluid being blocked when hose is over-bent or compressed; the present invention has several flow paths, while application, not all the flow paths suffer block or compression, fluid transportation function remains.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the prior art;

FIG. 2 is an assembly view of the present invention;

FIG. 3 is a cross-sectional view of the present invention;

FIG. 4 is a cross-sectional view of the first application the present invention;

FIG. 5 is a cross-sectional view of the second application the present invention;

FIG. 6 is a cross-sectional view of the third application the present invention.

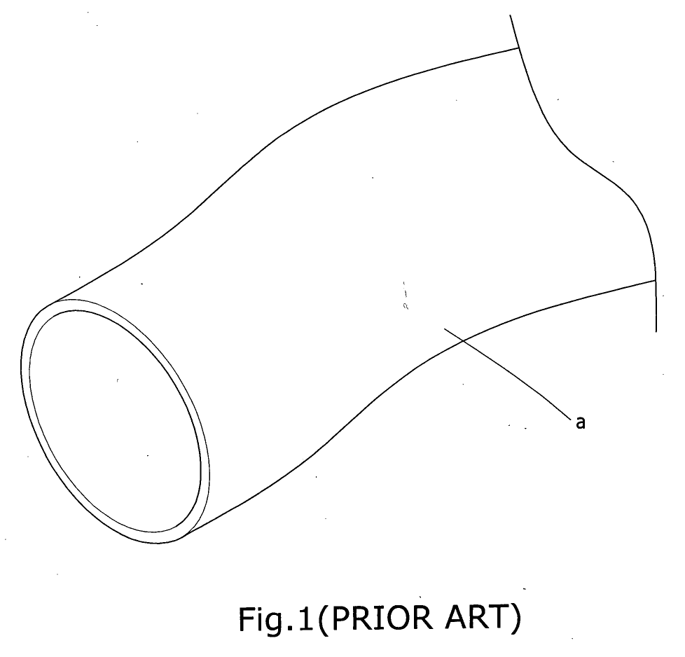

### DESCRIPTION OF THE PREFERRED EMBODIMENT

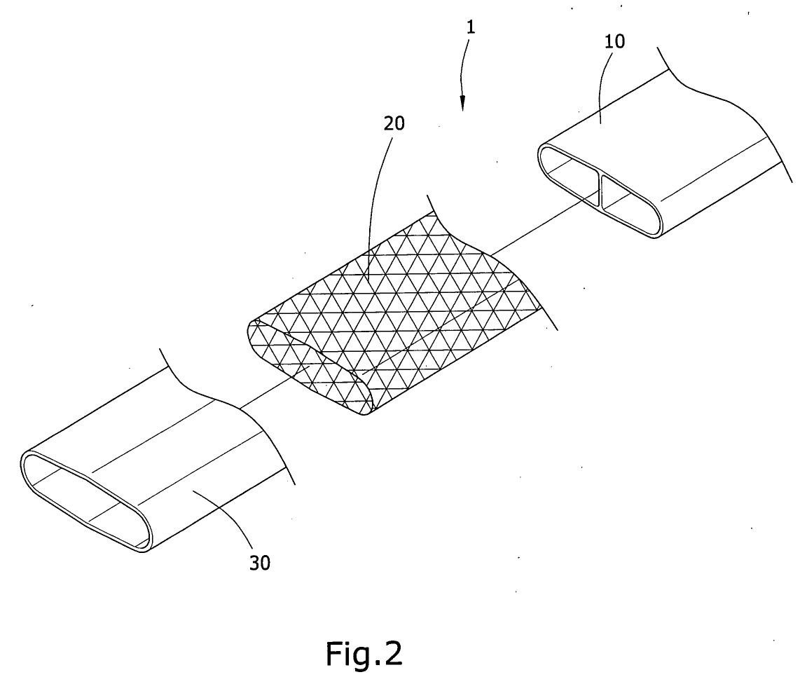

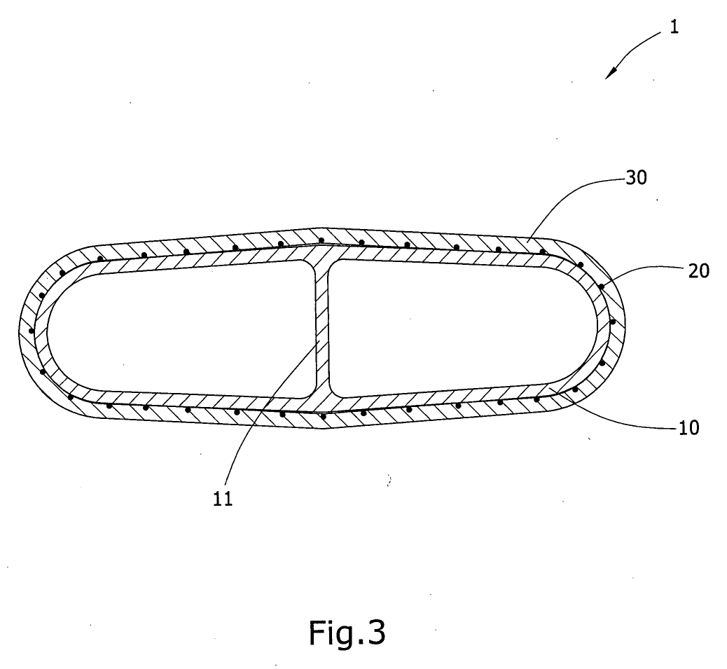

Referring to FIG. 2 and FIG. 3, the present invention comprises a flat hose 1 separated into two flow paths. The function of each component is described as following:

The flat hose 1 consists of inner layer 10, fiber layer 20 and outer layer 30; a connecting board 11 in parallel with flow direction subdivides the inner layer 10 into two flow paths; the fiber layer 20 is installed on the surface of the inner layer 10, the fiber layer 20 is made of polyester or yarn in net shape then wrapped around outer wall of the inner layer 10, finally above structure is combined with outer layer.

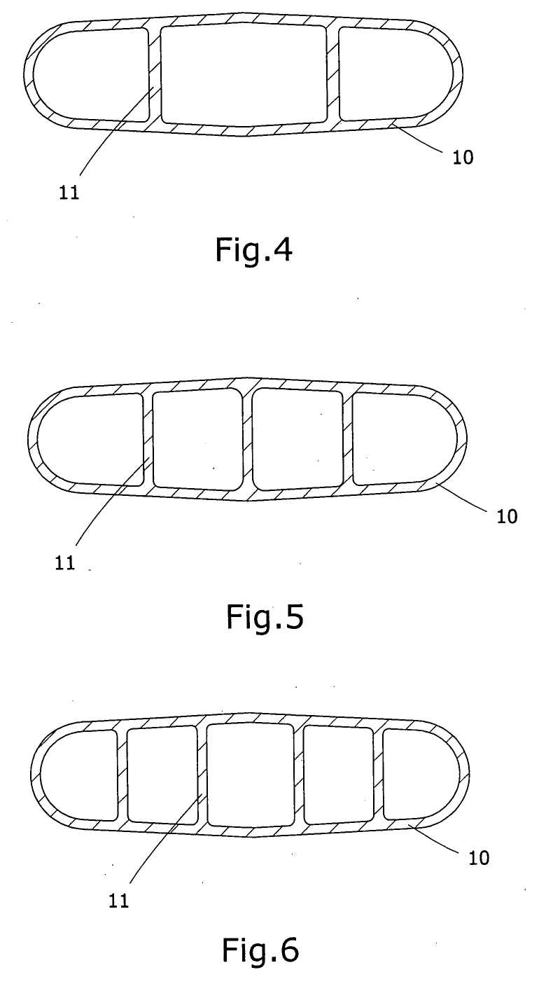

Referring to FIG. 4, FIG. 5 and FIG. 6, they are the cross-sectional views of the inner layer 10 with different number of connecting boards 11, these connecting boards 11 are in parallel with flow direction to offer proper support for upper and lower walls.

Based on above description, the connecting boards 11 inside the inner layer 10 are in parallel with flow direction to subdivide inner layer 10 into more than two flow paths for stronger support and hose strength, such can prevent fluid being blocked when hose is over-bent or compressed.

While a preferred embodiment of the invention has been shown and described in detail, it will be readily understood and appreciated that numerous omissions, changes and additions may be made without departing from the spirit and scope of the invention.

What is claimed is:

1. A kink proof flat type water hose comprising:
Inner layer, fiber layer and outer layer; a connecting board in parallel with flow direction subdivides said inner layer into two flow paths, the structure is in flat ellipse shape.

2. A kink proof flat type water hose comprising:
Inner layer, fiber layer and outer layer; several connecting boards in parallel with flow direction subdivides said inner layer into more than two flow paths, the structure is in flat ellipse shape.

3. The kink proof flat type water hose recited in claim 1, wherein said fiber layer is made of polyester in net shape then wrapped around outer wall of said inner layer.

4. The kink proof flat type water hose recited in claim 1, wherein said fiber layer is made of yarn in net shape then wrapped around outer wall of said inner layer.
